(19) United States
(12) Patent Application Publication
(10) Pub. No.: US 2024/0344441 A1
(43) Pub. Date: Oct. 17, 2024

(54) METHOD AND SYSTEM FOR MONITORING, COMMUNICATING AND CONTROLLING COMPLETION RELATED OPERATIONS

(71) Applicant: McCoy Global Inc., Edmonton (CA)

(72) Inventors: Gareth Dustin Sonnier, Austin, TX (US); Bing Deng, Edmonton (CA); Richard Chism, Round Rock, TX (US); Andrei Dmitriev, Edmonton (CA)

(21) Appl. No.: 18/652,481

(22) Filed: May 1, 2024

Related U.S. Application Data
(63) Continuation-in-part of application No. 16/839,445, filed on Apr. 3, 2020, now Pat. No. 12,000,269.
(60) Provisional application No. 62/829,780, filed on Apr. 5, 2019.

(51) Int. Cl. E21B 44/00; H04L 67/10; H04L 67/125; H04L 67/306

(52) U.S. Cl. CPC E21B 44/00; H04L 67/10; H04L 67/125; H04L 67/306

(57) ABSTRACT

A system is provided for remote monitoring, decision making and operating of on-site well operation equipment. The system includes an on-site make-up monitoring system for receiving data from one or more on-site sensor modules and configured to process in real time from the received data, connection profiles and curves relating to the tubular connection make-up operation; a cloud-based system configured to receive compressed data from the on-site make-up monitoring system and to reprocess the received data to replicate the connection profiles and curves relating to the tubular connection make up operation; and one or more dedicated remote portals accessible by one or more remote users for review or analysis of the connection profiles and curves generated by the cloud-based system, and to transmit instructions via the cloud-based system to the on-site make-up monitoring system for modifying the operation of the make-up equipment.

### FIELD

The present disclosure relates to methods and systems for remote monitoring, decision making, communicating, and operating of well completions.

### BACKGROUND

After an oil or gas well has been drilled, the well is completed by progressively threading and running downhole, sections of tubular to form a tubular string in the well bore. Tubular sections often come from the manufacturer with a coupling/collar piece already connected at one end. During tubular make-up, the pin end of one section of tubular is threaded into the coupling/collar of another tubular to create series of tubular joints that are then lowered down the wellbore for the purposes of maintaining wellbore integrity for operational extraction of oil or gas from the wells.

The integrity of the tubular connections is important to down hole operations, as well as avoiding over-tightening or damaging the tubular sections. There must therefore be a means for measuring make-up parameters and determining satisfactory tubular make-up, engagement, and seal. Manufacturers of premium grade connections provide a range of torque values and other parameters for proper make-up of specific connections. These parameters can be compared against measured parameters, which can then be plotted against number of turns, along with visual inspection of the connection by the operator, to monitor the connection and determine make-up acceptability.

During the tubular installation, there is a requirement to monitor and record the thread make-ups to ensure that the connection joints match the connection profile provided from the tubular manufacturers. The forces being applied to the tubular joint are measured and recorded using various sensors. The sensor data is presented graphically to the operator on-site to review and to determine satisfactory make-up of the joint before it is lowered into the well.

These sensors can be installed on any make-up or break out unit, including but not limited to a bucking unit, tongs, casing running tools (CRT), etc. depending on whether a connection is made at a factory, completions facility or on the well site.

The real-time collection and dissemination of rotational and torque parameters during make-up is a crucial aspect to acceptable make-up determination. It is important to be able to make an assessment of the tubular string make-up in real time during the make-up process.

Another challenge is having the correct level of support available on-site to make the proper decision on the quality of the connection made. Proper make-up of tubulars is crucial to the integrity of production operations. Make-up experts from the tubular manufacturer are typically needed to be on site to review real time make-up data with the operator and confirm that a tubular connection has been made up satisfactorily. The need for the on-site presence of the make-up expert, often known as a “thread representative,” adds considerable costs and logistics to make-up operations, particularly those in remote locations.

There is often also a desire on the part of the tubular manufacturer to make use of connection make-up data on-site and collate it with the manufacturer's make-up data, so, make-up data of the tubular to its collar can be analyzed for pass/fail by utilizing algorithms for connecting factory records with field operations.

There is a need to develop improved devices and systems for more accurately transmitting data in real time during tubular make-up and drilling with tubular operations. There is also a need for remote third parties to be able to communicate with operators on-site to make decisions on tubular make up.

### SUMMARY

A method is provided for remote monitoring and decision making with respect to one or more parameters of on-site tubular connection make up operations. The method includes the steps of
i) collecting data from one or more on-site sensor modules assigned to the on-site make up equipment, during joint make-up of tubing and casing connections;
ii) transmitting the collected data to an on-site make-up monitoring system;
iii) processing in real time within the on-site make-up monitoring system, connection profiles and curves relating to the tubular connection make-up operation;
iv) compressing and transmitting said collected data from the on-site make-up monitoring system to a cloud based system comprising a memory storage means;
v) reprocessing, by the cloud based system the collected data to replicate the connection profiles and curves relating to the tubular connection make up operation;
iv) accessing the connection profiles and curves relating to the tubular connection make up operation by one or more remote users via one or more dedicated remote portals for review or analysis; and
vi) transmitting instructions from any one or more of the one or more remote users via the remote portal and the cloud-based system back to at least the on-site make-up monitoring system for modifying the operation of the make-up equipment within predefined limits,
wherein the on-site make-up monitoring system provides on-site access to the received instructions.

A method is provided for automated monitoring, decision making and operation of one or more parameters of on-site well operation equipment. The method includes the steps of:
i) collecting data from one or more on-site sensor modules assigned to the on-site make up equipment, during joint make-up of tubing and casing connections;
ii) transmitting the collected data to an on-site make-up monitoring system; iii) processing in real time within the on-site make-up monitoring system, connection profiles and curves relating to the tubular connection make-up operation;
iv) assessing by the on-site make up monitoring system, the connection profiles and curves against connection specifications, tolerances, and thresholds; and
v) modifying via instructions from the on-site make-up monitoring system the operation of the make-up equipment within predefined limits.

A system is provided for remote monitoring, decision making and operating of one or more parameters of on-site well operation equipment. The system includes:
i) an on-site make-up monitoring system for receiving data from one or more on-site sensor modules assigned to the on-site make up equipment, said on-site make-up monitoring system configured to process in real time from the received data, connection profiles and curves relating to the tubular connection make-up operation;
ii) a cloud-based system comprising a memory storage mean configured to receive compressed data from the on-site make-up monitoring system and to reprocess the received data to replicate the connection profiles and curves relating to the tubular connection make up operation;
iii) one or more dedicated remote portals accessible by one or more remote users for review or analysis of the connection profiles and curves generated by the cloud-based system, said one or more dedicated remote portals configured to transmit instructions via the cloud-based system back to the on-site make-up monitoring system for modifying the operation of the make-up equipment within predefined limits,
wherein the on-site make-up monitoring system is configured to provide on-site access to the received instructions.

### BRIEF DESCRIPTION OF THE DRAWINGS

A further, detailed, description of the disclosure, briefly described above, will follow by reference to the following drawings of specific embodiments of the disclosure. The drawings depict only typical embodiments of the disclosure and are therefore not to be considered limiting of its scope. In the drawings:

FIG. 1 is one example of a tubular connection with which the present disclosure would be used;

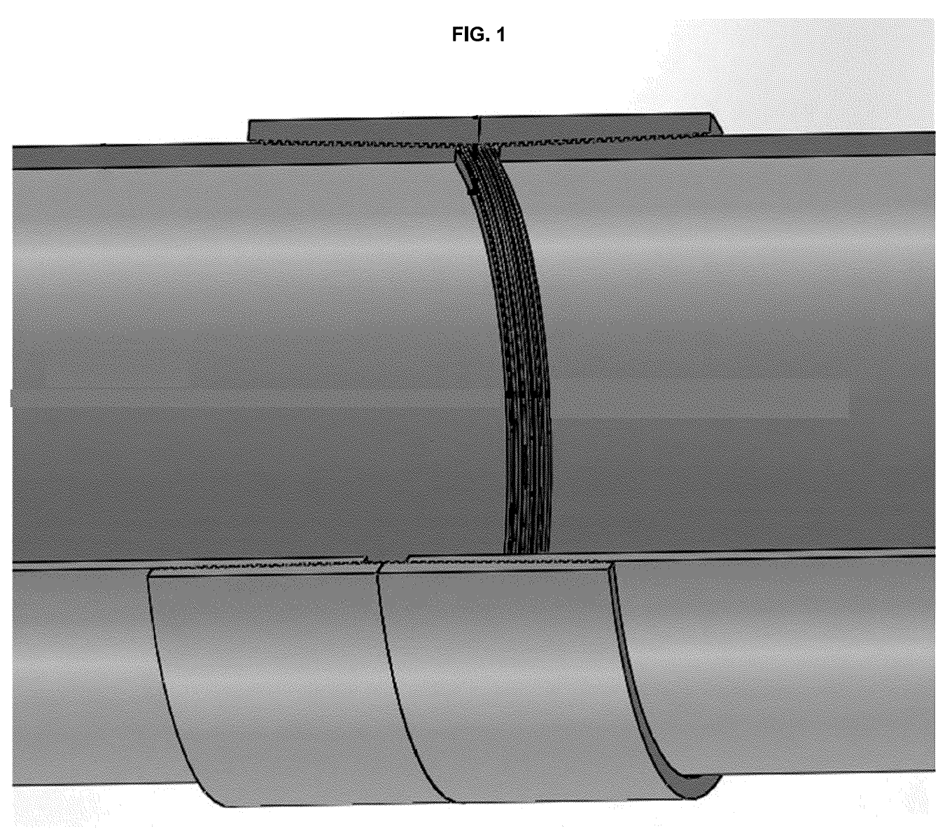

FIG. 2 illustrates one example of an operator performance statistics application of the present disclosure;

FIG. 3 is a schematic diagram of an overview of one example of the entire system of the present disclosure;

FIG. 4 is a schematic diagram of an example of the present system working with a third-party connections expert providing a virtual thread representative service;

FIG. 5a is a schematic diagram of an example of a bucking unit calibration monitoring aspect of the present system;

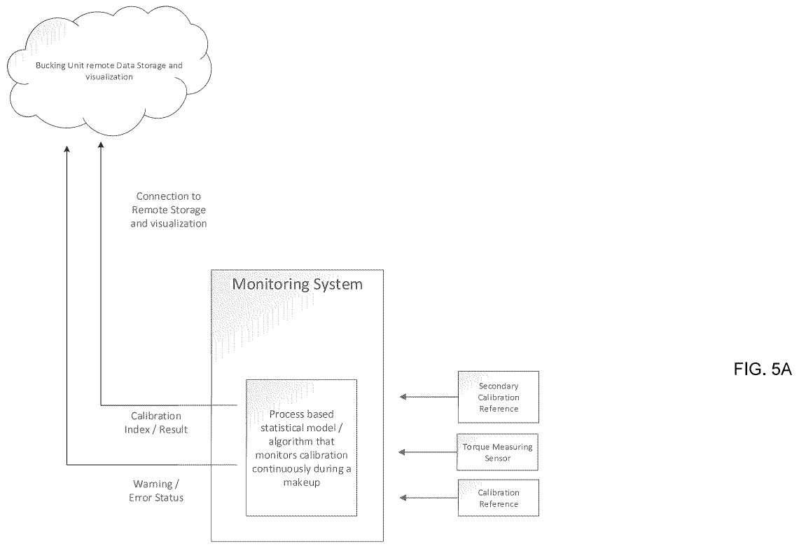

FIG. 5b is a block diagram of one example of a regression model for a bucking unit calibration monitoring aspect of the present system;

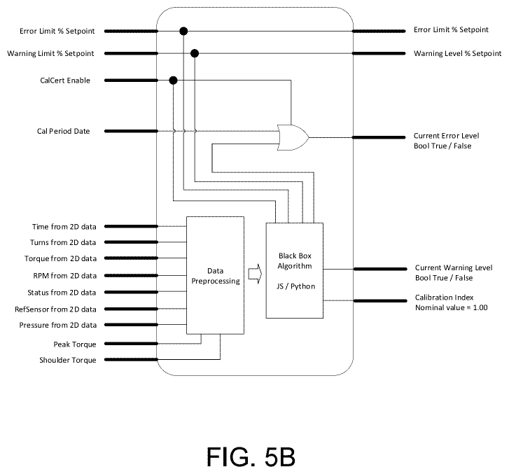

FIG. 6 is an example of an online tubular specifications library and an organization's tubular connection operational database that can be linked to one another and provided as part of the present system;

FIG. 7 is a schematic diagram of one example of the present system used with an automated algorithm or remote thread rep or a combination of both; and

FIG. 8 is a schematic diagram of one example of the present system for use in correlating factory tubular connection data with site connection data to produce a consolidated wellbore construction report.

The drawings are not necessarily to scale and in some instances, proportions may have been exaggerated in order to more clearly depict certain features.

### DETAILED DESCRIPTION

The description that follows and the embodiments described therein are provided by way of illustration of an example, or examples, of particular embodiments of the principles of various aspects of the present disclosure. These examples are provided for the purposes of explanation, and not of limitation, of those principles and of the disclosure in its various aspects.

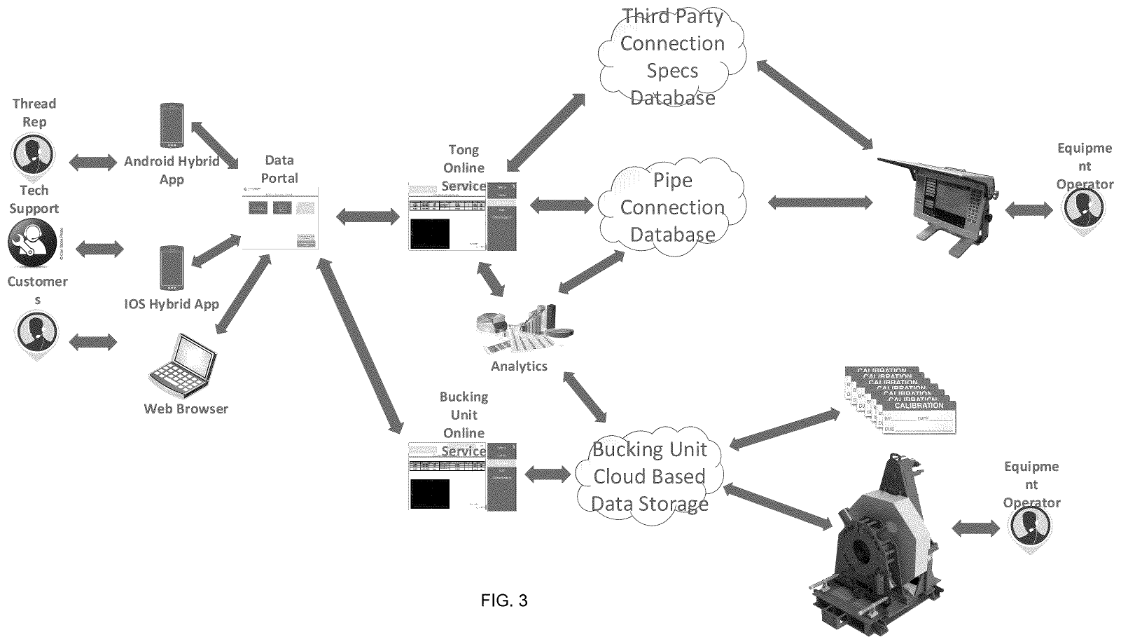

The present disclosure relates firstly to system that can be used with any number of torque turns make-up systems used to make-up tubular joints. One example of this system is illustrated in FIG. 3.

The equipment that can be used with the present system include bucking units, tubular running tools and tongs, collectively called make-up equipment. The make-up equipment is fitted with sensors for collecting make-up operation related data such as but not limited to, torque, number of turns, revolutions per minute (rpm), axial-loads, and other parameters of operation of the make-up equipment. The sensor data of make-up equipment is communicated to an onsite make-up monitoring system via an edge-based communications connection, such that data from the make-up equipment and from the make-up operation can be provided to the on-site make-up monitoring system without any lag or latency. The onsite make-up monitoring system uses the data to generate a connection profile, also often referred to as a torque-turns curve, which provides the onsite operator with make-up information for each particular tubular connection.

The onsite make-up monitoring system is connected to a cloud-based server to transmit raw, compressed sensor data to the cloud-based system in real-time and which can then be remotely viewed by remote users for decision making to support joint make-up.

Instructions and communication from remote parties can also be received through the present system and remote decision making and even operation of the equipment via communication with the on-site make-up monitoring system is also possible by input from authorized third parties.

The system can support network connectivity via satellite, cellular connection, ethernet, or any other known means in the art, to support uplink of data in real-time to the cloud or edge-based storage.

The cloud-based system receives the compressed raw sensor data via communication with the on-site make-up monitoring system for one or more make-up applications. The cloud-based system then replicates or re-processes the compressed sensor data to produce the same connection profile and torque-turns curves for communication to the remote users. The present system does not transmit the connections profiles and torque-turns curves generated in the onsite make-up monitoring system. Those files are immensely large, representing a huge data transfer that takes significant time. Instead, by transmitting only compressed raw data to the cloud-based system, the present system avoids traditional lags and latency. Reprocessing of the raw data at the cloud-based system and replication of the connection profile and curves takes comparatively little time or energy and the remote user is thus provided with make-up connection information in near-real time as the onsite operator.

In this way the present system provides an industrial internet of things (IIOT) solution to make-up equipment. For the purposes of the present disclosure, the cloud is understood to refer to data centers available over a network, used to handle and distribute functions over multiple locations from central servers. The cloud thus forms an on-demand availability of computer system resources, especially data storage and computing power, without direct active management by the remote user. In cases where the cloud connection to the remote user is relatively close, it may be designated an edge server, or edge-based system.

The present cloud connected system has the ability to provide real time review, decision making and operation from any number of remote users at different locations on each connection made, using cloud or edge processing, based on an algorithm defined for each piece of make-up equipment.

### Remote Access Portal

With reference to FIG. 3, the present system is preferably presented on a cross platform portal accessible by any number of applications, including but not limited to web, IOS and Android applications, to provide access and security for all remote users and operators. It would be understood by a person of skill in the art that the present system does not need to be device or operating system limited. The present system can be supported on a platform to an online point of access for all operators, remote users, and services.

Each dedicated access portal will include administrative and/or user self-registration for easy account management, the ability to set up organizations within an account, organizational account management with permission controls for users, the ability for the customer to add and delete services and secure access.

Users of the dedicated remote access portal can include the company owning the drilling rig and performing drilling of the well, the company conducting the make-up operation, completions operators, tubular manufacturers, and their thread representatives, well owners, production company and any of their respective staff. Users can be local on-site of the completion operation, such as operators, or they can be remotely located such as remote thread representatives. Certain users will also have the ability to share remote access with others, thereby providing a one-to-many relationship with the data.

The portal will also provide the online service module support for a remote thread representative capability. Users of the system via the portal will include operators both on site and remotely, technical support from the equipment manufacturer, thread experts from the tubular manufacturer, consultants, among others.

Once a remote user is logged into their respective dedicated remote access portal, depending on permissions and access level of that remote user, the user can view connection profiles, torque turns curves generated by the cloud-based system and other connection and make-up operations related data stored in the cloud-based system. The remote user may, with information of connection operations, approve a particular tubular connection as being make up properly. Alternatively, the remote user may, via the remote access portal and through the cloud-based system, communicate to the onsite operator at the onsite make-up monitoring system that the connection has not been made up properly or recommend changes to the operational steps.

The remote access portal allows for parties such as a thread representative to provide real-time makeup and connection feedback from anywhere in the world.

### Operator Performance

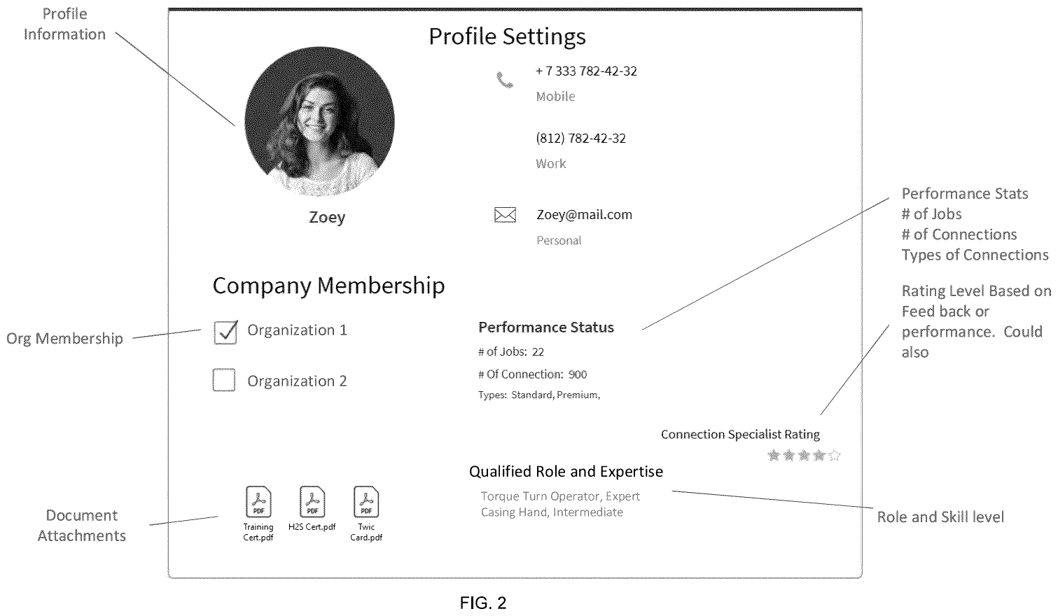

With reference to FIG. 2, the present cloud connected system can potentially also maintain historical performance information and statistics about operators including overall rating and reviews of the operator, which can be called up on demand. This information can be accessed by any number of entities including management who employ the operator, companies making the tubular handling equipment, remote or virtual thread representatives from the tubular manufacturing company and even the operator herself/himself.

The aggregation of operator-specific data and performance could include certifications, training, along with connection experience and other job-related experience for the operator.

### Remote Thread Representative

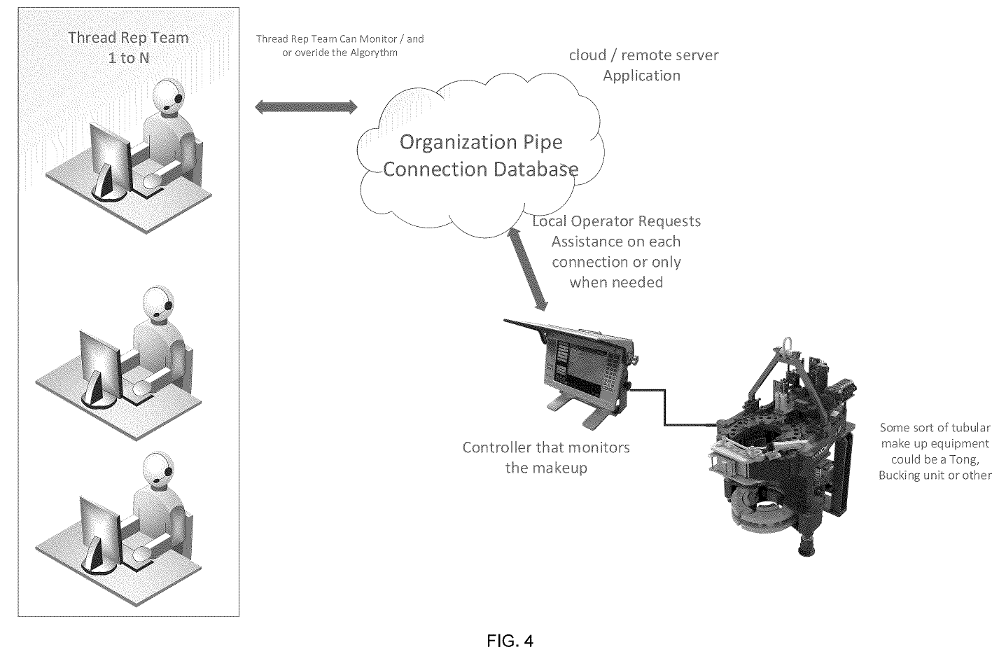

With reference to FIG. 4, the present system can further provide connection via the internet in real time to one or more virtual thread representatives who can login to their remote access portal to remotely view connection data as a connection is made up at the job site and advise on proper make-up of the tubular joints. The remote or virtual thread representative can be an expert from the tubular manufacturer, or an internal or external consultant. This can serve to eliminate the need for thread representatives to be physically on site for all make-up operations.

The system further provides hardware and software for allowing a remote team of one or more individuals to view in real time and analyze the make-up operation and provide comments and recommendations to either accept or reject the made-up joint. This tool will allow the expert to remotely review and analyze the connection and communicate via chat, text, video, or other forms of communication through the remote access portal to the onsite make-up monitoring system. Using job cards and a queue system the time sensitive analysis can be completed without interrupting the performance of the make-up operation. This reduces the need for expertise required on site when running tubular make-up.

It is common in completion operations for a senior make-up operator to be on site and supervise a junior on-site operator. This practice ensures quality and provides training, but also adds expense, time, and complexity, since the senior operator can only provide supervision and support to the single junior operator he or she is working with on site.

The present system provides a means by which the senior operator, working in a single central location, can supervise, advise, and even run the make up operations for more than one junior operator in more than one location.

In many cases, a remote operator can conduct the whole make up operation remotely, with only the need for a local technician to make only the preliminary set up. Online job discussion between operators and remote experts captures job events such as make-ups completion, lot changes and official comment during a job, as well as the recorded job statistics and information.

### Central Library and Database

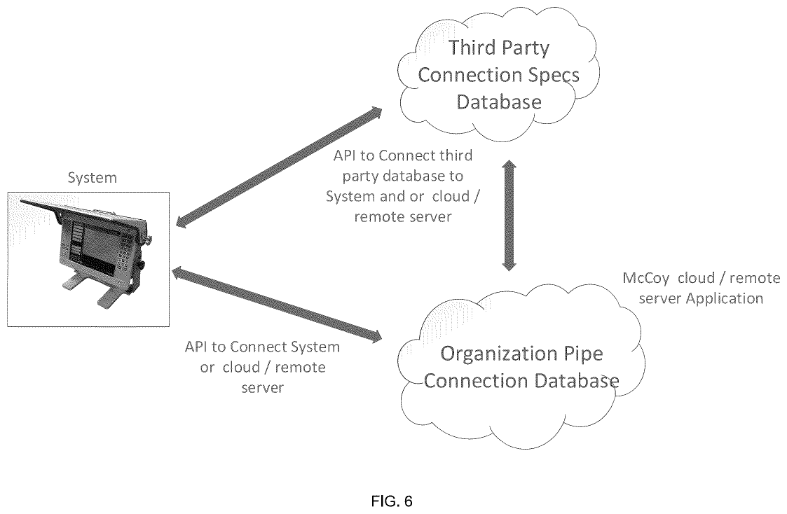

With reference to FIG. 6, the present cloud-based system can access through its dedicated web connections, central repositories of libraries of connection profile specifications provided by the tubular manufacturer. From these repositories of libraries, which are constantly updated by the tubular manufacturers, connection profile specifications of a particular tubular type can be loaded and set as the connection criteria for that particular tubular joint, ahead of make-up operations. This provides an accessible and loadable database of tubular make-up specifications.

The cloud-based system can also be programmed to store the particular make-up requirements, including tolerances and resolutions of acceptable connections, for make-up operator companies or for well producer companies, or other end users. By this system, the end user's particular region or environment of completions and operations can be taken into account and the tolerances they have for accepting a made-up tubular connection. The present system can also set up a baseline for all of a company's fleet of onsite make-up monitoring systems, using the cloud database to synchronize these system's setting and connection information. This avoids discrepancies from site to site, operator to operator and ensure consistency across a producer or end users' fleet of operations.

The cloud-based system may also contain a library of system settings for a fleet of tubular make up equipment and for equipment operating parameters, as well as historical operational and make-up data. The online connection library provides the ability for an organization to create a centralized library of settings for download and synchronizing the torque turns system.

The system also makes it possible to track response time and proves a multi graph overlay of the last several jobs to review for consistency, over a lot or batch of pipe.

Adaption for Use with Automated Make-Up Algorithms

The present system may also be used with edge or cloud-based algorithms that can automate connection make-up. In such embodiments, where remote user input, such as a remote thread expert, is not required, the entire make-up monitoring and decision-making operation can be conducted at and via the onsite make-up, monitoring system, which can collect the sensor data and generate connection profiles and torque-turns curves. The on-site make-up monitoring system in such embodiments includes decision-making algorithms based on make-up specifications from the tubular manufacturer and rules with respect to acceptable resolutions and tolerances of the end user to automatically operate the tubular make-up equipment for acceptable tubular connection make-up.

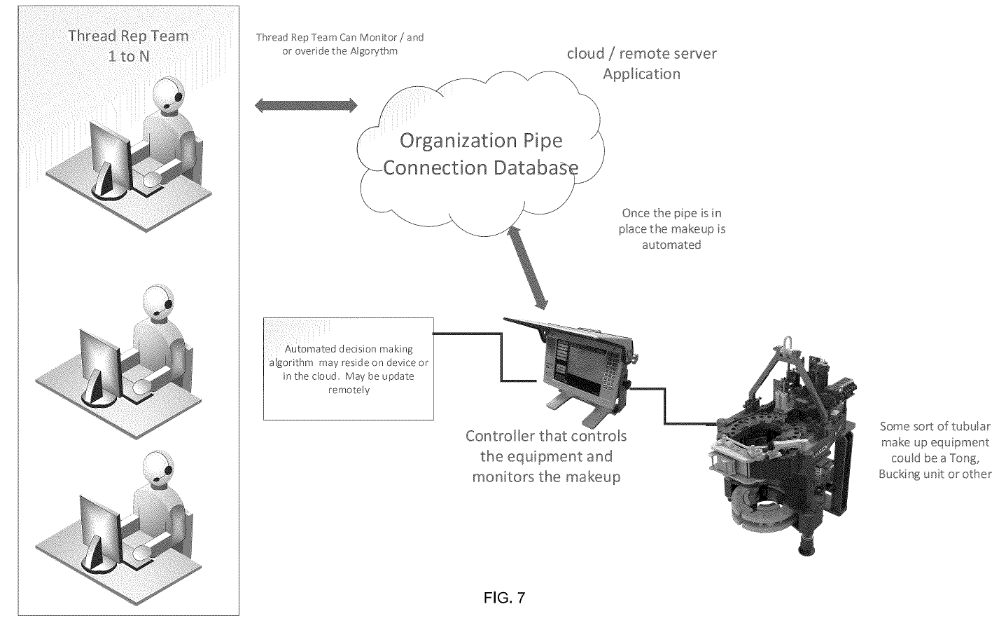

One example of this use of the system is shown in FIG. 7.

### Communicating Site Connection Data to Tubular Manufacturers

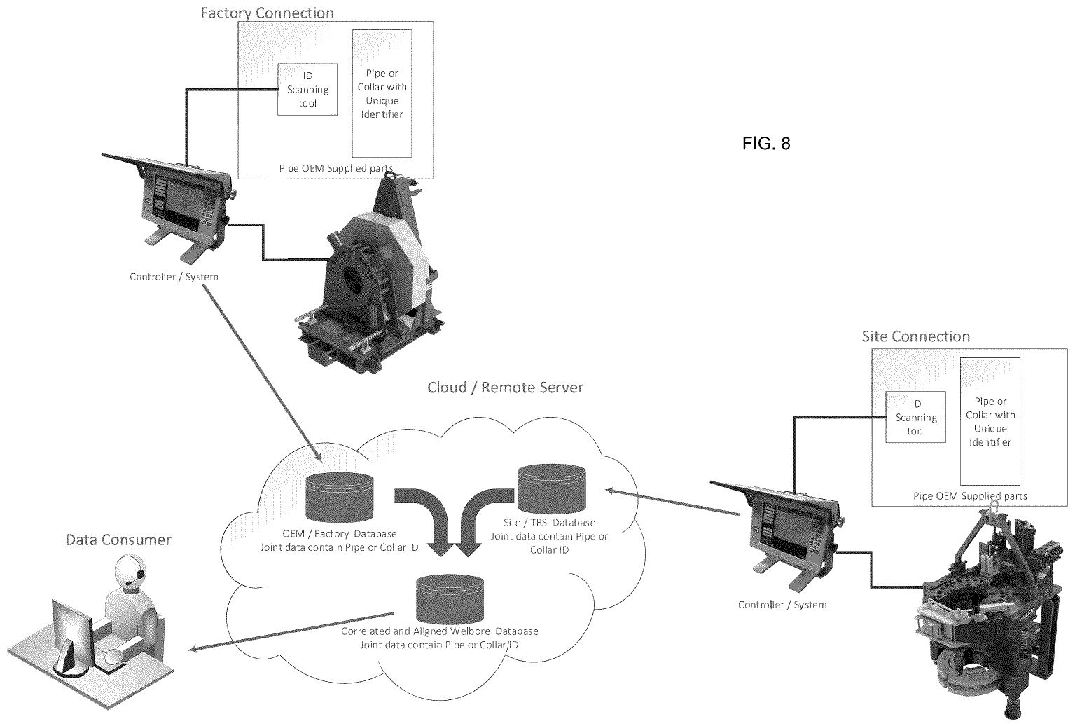

In a further embodiment, illustrated in FIG. 8, the present system can provide on-site make up connection data on specific tubular joints that are connected to specific tubular collars at the well-site connection operation. This can be collated with connection data for the tubular to collar connection operations connected at the factory. When the factory connection data is collated with onsite connection data, including tubular/collar identification, factory make up settings and other information, a complete wellbore construction make-up report can be created to that can aid in identification of failures and whether those failures stem from factory make-up connections or well site make-up connections.

The previous description of the disclosed embodiments is provided to enable any person skilled in the art to make or use the present disclosure. Various modifications to those embodiments will be readily apparent to those skilled in the art, and the generic principles defined herein may be applied to other embodiments without departing from the spirit or scope of the disclosure. Thus, the present disclosure is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A method for remote monitoring and decision making with respect to one or more parameters of on-site tubular connection make up operations, said method comprising the steps of:
i) collecting data from one or more on-site sensor modules assigned to the on-site make up equipment, during joint make-up of tubing and casing connections;
ii) transmitting the collected data to an on-site make-up monitoring system;
iii) processing in real time within the on-site make-up monitoring system, connection profiles and curves relating to the tubular connection make-up operation;
iv) compressing and transmitting said collected data from the on-site make-up monitoring system to a cloud based system comprising a memory storage means;
v) reprocessing, by the cloud based system the collected data to replicate the connection profiles and curves relating to the tubular connection make up operation;
iv) accessing the connection profiles and curves relating to the tubular connection make up operation by one or more remote users via one or more dedicated remote portals for review or analysis; and
vi) transmitting instructions from any one or more of the one or more remote users via the remote portal and the cloud-based system back to at least the on-site make-up monitoring system for modifying the operation of the make-up equipment within predefined limits,
wherein the on-site make-up monitoring system provides on-site access to the received instructions.

2. The method according to claim 1, wherein the data from the sensor module is transmitted to the on-site make-up monitoring system via edge-based transmission.

3. The method of claim 1, further comprising sharing, by one or more remote users, remote access to the remote access portal with one or more other remote users.

4. The method of claim 1, further comprising accessing, by the present cloud-based system, one or more central repositories of libraries of connection profile specifications provided by a tubular manufacturer.

5. The method of claim 1, further comprising storing within the cloud-based system particular make-up requirements, including tolerances and resolutions of acceptable connections, of end users.

6. The method of claim 5, further comprising transmitting from the cloud-based system a baseline of make-up requirements to one or more onsite make-up monitoring systems of an end user to synchronize setting and connection information across a feet of onsite make-up monitoring systems.

7. The method according to claim 1, further comprising storing in the cloud-based system data regarding an operator or operators of the on-site make up equipment, including operator performance, overall ratings, certifications, and number of operations completed.

8. The method according to claim 1, further comprising via the cloud-based system, collating well-site make up connection data on specific tubular joints with connection data for tubular to collar connection operations connected at a tubular manufacturer's location to generate a complete wellbore construction make-up report.

9. A method for automated monitoring, decision making and operation of one or more parameters of on-site well operation equipment, comprising:
i) collecting data from one or more on-site sensor modules assigned to the on-site make up equipment, during joint make-up of tubing and casing connections;
ii) transmitting the collected data to an on-site make-up monitoring system;
iii) processing in real time within the on-site make-up monitoring system, connection profiles and curves relating to the tubular connection make-up operation;
iv) assessing by the on-site make up monitoring system, the connection profiles and curves against connection specifications, tolerances, and thresholds; and
v) modifying via instructions from the on-site make-up monitoring system the operation of the make-up equipment within predefined limits.

10. A system for remote monitoring, decision making and operating of one or more parameters of on-site well operation equipment, said system comprising:
i) an on-site make-up monitoring system for receiving data from one or more on-site sensor modules assigned to the on-site make up equipment, said on-site make-up monitoring system configured to process in real time from the received data, connection profiles and curves relating to the tubular connection make-up operation;
ii) a cloud-based system comprising a memory storage mean configured to receive compressed data from the on-site make-up monitoring system and to reprocess the received data to replicate the connection profiles and curves relating to the tubular connection make up operation; and
iii) one or more dedicated remote portals accessible by one or more remote users for review or analysis of the connection profiles and curves generated by the cloud-based system, said one or more dedicated remote portals configured to transmit instructions via the cloud-based system back to the on-site make-up monitoring system for modifying the operation of the make-up equipment within predefined limits,
wherein the on-site make-up monitoring system is configured to provide on-site access to the received instructions.

11. The system according to claim 10, wherein the on-site make-up monitoring system comprises edge-based transmission to receive data from the sensor module.

12. The system of claim 10, wherein the remote access portal is shareable by one or more remote users with one or more other remote users.

13. The system of claim 10, wherein the present cloud-based system is configured to access one or more central repositories of libraries of connection profile specifications provided by a tubular manufacturer.

14. The system of claim 10, wherein the cloud-based system is configured to store particular make-up requirements, including tolerances and resolutions of acceptable connections, of end users.

15. The system of claim 14, further comprising transmitting from the cloud-based system a baseline of make-up requirements to one or more onsite make-up monitoring systems of an end user to synchronize setting and connection information across a feet of onsite make-up monitoring systems.

16. The system according to claim 10, wherein the cloud-based system is configured for storing data regarding an operator or operators of the on-site make up equipment, including operator performance, overall ratings, certifications, and number of operations completed.

17. The system according to claim 10, the cloud-based system is configured to collate well-site make up connection data on specific tubular joints with connection data for tubular to collar connection operations connected at a tubular manufacturer's location to generate a complete wellbore construction make-up report.
